(19) United States
(12) Patent Application Publication
(10) Pub. No.: US 2015/0271649 A1
(43) Pub. Date: Sep. 24, 2015

(54) METHOD AND APPARATUS FOR A BACK CHANNEL IN A HALF-DUPLEX COMMUNICATION SYSTEM

(71) Applicant: MOTOROLA SOLUTIONS, INC., Schaumburg, IL (US)

(72) Inventors: CHI TU TRAN, Weston, FL (US); DAVID E. KLEIN, Davie, FL (US); DAVID J. LEY, Plantation, FL (US)

(73) Assignee: MOTOROLA SOLUTIONS, INC., Schaumburg, IL (US)

(21) Appl. No.: 14/218,299

(22) Filed: Mar. 18, 2014

(51) Int. Cl. H04W 4/10; H04W 68/12; H04L 5/16

(52) U.S. Cl. CPC H04W 4/10; H04L 5/16; H04W 68/12

(57) ABSTRACT

A method and apparatus for a back channel implemented by a transmitting device in a half-duplex communication system includes monitoring for voice activity detection, indicative of an absence of human speech, while the transmitting device is transmitting on a half-duplex channel of the half-duplex communication system; transmitting a notification of a back channel opportunity to other devices on the half-duplex channel responsive to the voice activity detection; and switching to a receiving mode to receive data on the back channel while still maintaining control of the half-duplex channel. A method for a back channel implemented by a receiving device is also described.

### BACKGROUND OF THE INVENTION

The present disclosure relates generally to half-duplex communication systems such as, for example, in wireless communication systems with push-to-talk (PTT) services. In a half-duplex communication system, a communication device can either receive or transmit at a single instance, e.g. in a half-duplex communication system, only one party can talk at a time. If there is a need to communicate to a user who is presently transmitting in a half-duplex communication system, there are no current mechanisms available within the half-duplex communication system. That is, conventionally, a transmitting user in a half-duplex communication system has control of the channel and there are no mechanisms to provide feedback to the transmitting user in the half-duplex communication system. For example, an exemplary half-duplex communication system can include Land Mobile Radio (LMR) and the application can include PTT. There is a significant want to be able to alert a field user at any point, including when the user is utilizing their LMR device. But, half-duplex communication devices are not able to manage this process currently. A work around can include a second full transceiver in a different band/technique/etc. to provide another channel outside of the half-duplex communication system. Disadvantageously, this comes at a cost/size/battery or the use of lower power techniques that have limited range.

Accordingly, there is a need for a method and apparatus for a back channel in a half-duplex communication system.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a network diagram of a communication system operating in accordance with some embodiments.

FIG. 2 is a block diagram of a communication device, which may be used in the communication system of FIG. 1 or the like, in accordance with some embodiments.

FIG. 3 is a block diagram of an exemplary backchannel operation in a half-duplex communication system in accordance with some embodiments.

FIG. 4 is a flowchart of a method for a back channel implemented by a transmitting device in a half-duplex communication system in accordance with some embodiments.

FIG. 5 is a flowchart of a method for a back channel implemented by a receiving device in a half-duplex communication system in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In various exemplary embodiments, a method and apparatus are described which, in a half-duplex communication system, utilize an ad hoc non-deterministic process to create an opportunistic feedback loop that allows information sharing during a traditional dedicated half-duplex action based upon a voice detection algorithm already available in the digital half-duplex mobile devices. The method and apparatus use the silent times during a half-duplex transmission to offer a back channel opportunity for another device to share status with the transmitting unit without the transmitting unit having to release ownership of the channel in half-duplex operation.

In an exemplary embodiment, a method for a back channel implemented by a transmitting device in a half-duplex communication system includes monitoring for voice activity detection, indicative of an absence of human speech, while the transmitting device is transmitting on a half-duplex channel of the half-duplex communication system; transmitting a notification of a back channel opportunity to other devices on the half-duplex channel responsive to the voice activity detection; and switching to a receiving mode to receive data on the back channel while still maintaining control of the half-duplex channel.

In another exemplary embodiment, a method for a back channel implemented by a receiving device in a half-duplex communication system includes receiving voice and/or data from a transmitting device on a half-duplex channel of the half-duplex communication system; detecting a notification of a back channel opportunity from the transmitting device while the transmitting device still maintains control of the half-duplex channel; and switching to a transmitting mode to transmit a message on the back channel responsive to the notification and a determined need to transmit the message to the transmitting device while the transmitting device still maintains control of the half-duplex channel.

In yet another exemplary embodiment, an apparatus operating a back channel in a half-duplex communication system includes a network interface configured to communicate on a half-duplex channel in the half-duplex communication system; a microphone; a processor communicatively coupled to the network interface and the microphone; and memory storing instructions that, when executed, cause the processor to: monitor for voice activity detection, indicative of an absence of human speech, from the microphone while transmitting via the network interface on the half-duplex channel; transmit a notification of a back channel opportunity to other devices on the half-duplex channel responsive to the voice activity detection; and switch the network interface to receive data on the back channel while still maintaining control of the half-duplex channel.

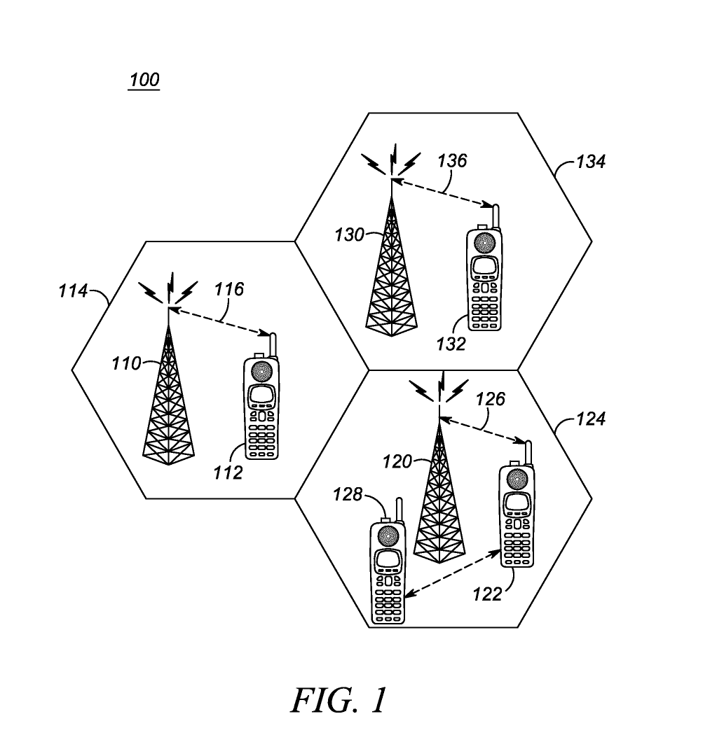

FIG. 1 is a network diagram of a communication system 100 operating in accordance with some embodiments. The communication system 100 is depicted in a generalized manner to include three wireless coverage areas 114, 124, 134 for ease of illustration, and those of ordinary skill in the art will recognize other embodiments are also contemplated. The wireless coverage area 114 includes a half-duplex communication device 112 communicatively coupled to an infrastructure device 110 such as a tower, base station, repeater, or the like, for operation in an infrastructure mode. Similarly, the wireless coverage areas 124, 134 include half-duplex communication devices 122, 128, 132 which can be communicatively coupled to infrastructure devices 120, 130. The half-duplex communication devices 122, 128 can communicate in peer-to-peer, direct, or ad hoc mode i.e. without an infrastructure device 110. Even though wireless communication devices are illustrated herein, the method and apparatus is equally applicable to wired or fixed communication devices as well as devices operating in any modes such as infrastructure or ad hoc.

The half-duplex communication devices 112, 122, 128, 132 are equipped with transceivers, memories, and processing devices operatively coupled and adapted, arranged, configured and designed to carry out the associated functionality, including any functionality needed to implement the mechanisms described herein. The communication system 100 and the half-duplex communication devices 112, 122, 128, 132 are further equipped with any other elements needed for a commercial embodiment. As referred to herein, the half-duplex communication devices 112, 122, 128, 132 include, but are not limited to, devices commonly referred to as access terminals, mobile radios, mobile stations, subscriber units, user equipment, mobile devices, or any other device capable of operating in a half-duplex environment. Examples of wireless communication devices include, but are not limited to, two-way radios, mobile phones, Personal Digital Assistants (PDAs), and laptops or any other electronic device capable of conducting a half-duplex communication. In an exemplary embodiment, the half-duplex communication devices 112, 122, 128, 132 can be LMR radios.

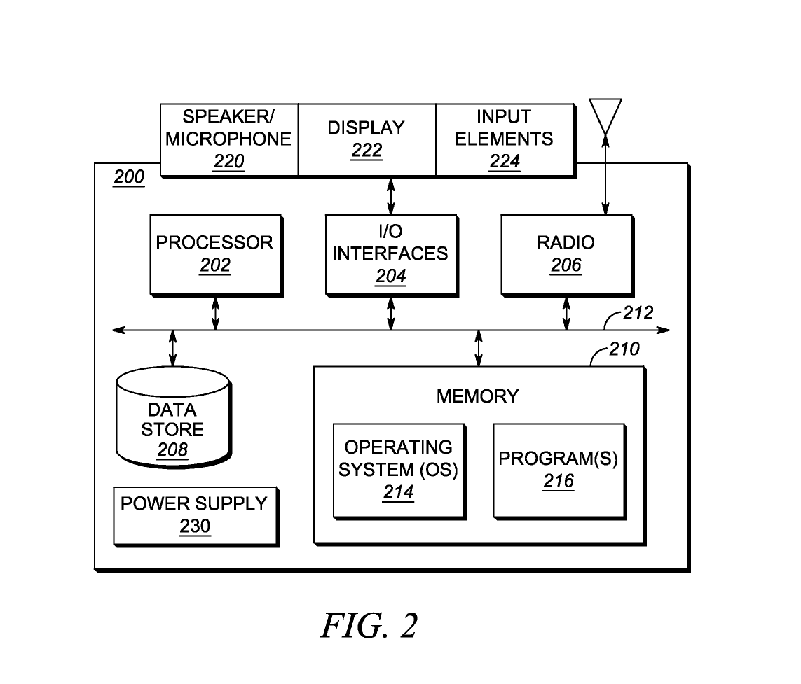

FIG. 2 is a block diagram of a communication device 200, which may be used in the communication system 100 or the like, in accordance with some embodiments. For example, the communication device 200 is an example of the half-duplex communication devices 112, 122, 128, 132. The communication device 200 can be a digital device that, in terms of hardware architecture, generally includes a processor 202, input/output (I/O) interfaces 204, a radio 206, a data store 208, and memory 210. It should be appreciated by those of ordinary skill in the art that FIG. 2 depicts the communication device 200 in an oversimplified manner, and a practical embodiment may include additional components and suitably configured processing logic to support known or conventional operating features that are not described in detail herein. The components (202, 204, 206, 208, and 202) are communicatively coupled via a local interface 212. The local interface 212 can be, for example but not limited to, one or more buses or other wired or wireless connections, as is known in the art. The local interface 212 can have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 can be any custom made or commercially available processor, a central processing unit (CPU), an auxiliary processor among several processors associated with the communication device 200, a semiconductor-based microprocessor (in the form of a microchip or chip set), or generally any device for executing software instructions. When the communication device 200 is in operation, the processor 202 is configured to execute software stored within the memory 210, to communicate data to and from the memory 210, and to generally control operations of the communication device 200 pursuant to the software instructions. In an exemplary embodiment, the processor 202 can include a mobile optimized processor such as optimized for power consumption and mobile applications. The I/O interfaces 204 can be used to receive user input from and/or for providing system output. Three examples of the I/O interfaces 204 can include a speaker/microphone 220, a display 222, and input elements 224. The speaker/microphone 220 is configured to capture and transmit audio from a user. The display 222 can include a display device such as a liquid crystal display (LCD), touch screen, and the like. The input elements 224 can include, for example, a keypad, a touch screen, a scroll ball, a scroll bar, buttons, bar code scanner, and the like. The I/O interfaces 204 can also include, for example, a serial port, a parallel port, a small computer system interface (SCSI), an infrared (IR) interface, a radio frequency (RF) interface, a universal serial bus (USB) interface, proprietary ports like 30-pin or 19-pin connectors, and the like. The I/O interfaces 204 can include a graphical user interface (GUI) that enables a user to interact with the communication device 200. The I/O interfaces 204 can also include a mechanism for transmitting on a half-duplex channel via the radio 206 such as, for example, a PTT activation mechanism.

The radio 206 enables wireless communication to an external device or network, such as in the communication system 100. Any number of suitable wireless data communication protocols, techniques, or methodologies can be supported by the radio 206, including, without limitation: RF; IrDA (infrared); LMR; Digital Mobile Radio (DMR); Frequency Division Multiple Access (FDMA); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. In the various exemplary embodiments described herein, the communication device 200 is a half-duplex device. That is, any of the foregoing wireless data communication protocols, techniques, or methodologies that are full duplex in nature would be operating in half duplex dedicated line operation for the various exemplary embodiments described herein. The radio 206 is generally a network interface enabling the communication device 200 to communicate on a network such as the communication system 100. Further, those of ordinary skill in the art will recognize the radio 206 is presented for wireless communication, but the communication device 200 can also be a wired or fixed communication device where the radio 206 is substituted for another type of network interface such as a wired Ethernet port or the like. The radio 206 can be configured in a receiving mode where the transceiver, antenna, and other components are configured to receive data over a connection and a transmitting mode where the transceiver, antenna, and other components are configured to transmit data over the connection. In a half-duplex communication system, the radio 206 is configured to switch between the transmitting mode and the receiving mode as appropriate.

The data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. The memory 210 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 210 may incorporate electronic, magnetic, optical, and/or other types of storage media. Note that the memory 210 may have a distributed architecture, where various components are situated remotely from one another, but can be accessed by the processor 202. The software in memory 210 can include one or more software programs, each of which includes an ordered listing of executable instructions for implementing logical functions. In the example of FIG. 2, the software in the memory 210 includes a suitable operating system (O/S) 214 and programs 216. The operating system 214 essentially controls the execution of other computer programs, and provides scheduling, input-output control, file and data management, memory management, and communication control and related services. The programs 216 may include various applications, add-ons, etc. configured to provide end user functionality with the communication device 200. In a typical example, the end user typically uses one or more of the programs 216 along with a network such as the communication system 100. Additionally, the communication device 200 can include a power supply 230 and associated charging mechanisms.

The communication device 200, with coordination between the processor 202, the memory 210, and the speaker/microphone 220, can include voice activity detection (VAD). Voice activity detection (VAD), also known as speech activity detection or speech detection, is a technique used in speech processing in which the presence or absence of human speech is detected. VAD can facilitate speech processing, and can also be used to deactivate some processes during non-speech section of an audio session: it can avoid unnecessary coding/transmission of silence, saving on computation and on network bandwidth. The VAD can be performed in a vocoder which can include hardware, software, and/or firmware in the speaker/microphone 220 (as well as in the processor 202 and/or the memory 210, or a combination thereof). A VAD flag, as described herein, is a determination by a transmitting communication device 200 of the absence of human speech. Such a determination is typically done over an entire period that the communication device 200 is transmitting. In various exemplary embodiments described herein, the method and apparatus utilize VAD and the VAD flag to give some opportunity for feedback to be delivered to a transmitting communication device 200 on a half-duplex communication channel. Various, the vocoder in conventional communication devices already performs this VAD functionality. The method and apparatus leverage this existing determination to provide opportunistic feedback to the transmitting communication device 200 in a half-duplex communication system. Note, the transmitting communication device 200 makes a local determination using the VAD flag that there is an opportunity for the back channel. Thus, it is the transmitting device that determines when the back channel is open.

Variously, the method and apparatus use the VAD flag to identify if there are small segments of voice gaps that the communication device 200 could use as an opportunity to switch from transmitting to receiving to receive status or other alert messaging from associated receiving communication devices 200, alternative transmitting communication devices 200, the infrastructure, or the like. That is, the method and apparatus utilize the VAD flag for determined opportunities to provide the back channel based on absences of voice, i.e. moments where speech is not detected based on monitoring and tracking local to the transmitting device. This provides an ad hoc non-deterministic process to create an opportunistic feedback solution that allows an enhanced communication process compared to a traditional dedicated half-duplex process. For example, the method and apparatus can provide approximately 20 msec or more where a transmitting communication device 200 can receive a message via a back channel on the half-duplex communication channel. That is, detection of the VAD flag can represent approximately 20 msec which can be used to transmit to the transmitting communication device 200. For example, with VAD, in a time average operation, it takes about 60-70 msec to determine if there is audio, it takes about 20-30 msec for the radio 206 to switch between transmitting to receiving. So, upon detecting the VAD flag after 60-70 msec, the transmitting communication device 200 can send a flag to receiving communication devices 200 or the infrastructure and then switch to receiving to receive messages in the back channel. Upon detection of speech, the transmitting communication device 200 can return back to the radio 206 transmitting. Note, with enhancements in hardware elements and improved designs, the transmitter to receiver and back switch times may improve over the aforementioned example such that the widow size for the back channel slots could become considerably larger than the 20 msec described herein.

Various applications and uses are contemplated by the method and apparatus. In an exemplary application, the speaker/microphone 220 could be used for ambient sound transmitting/recording. For example, the communication device 200 could be used as a microphone for an in-vehicle Digital Video Recorder (DVR), via the communication device 200 connecting to a Digital Vehicular Repeater System (DVRS), which is in turn connected to the DVR. In another exemplary application, the method and apparatus can provide enhanced direct mode operation for half-duplex communications. For example, the method and apparatus can be used to alert a speaker that someone on the same channel is pushing an emergency button or that someone with higher priority is trying to speak, i.e. a higher priority user. Various other applications are also contemplated.

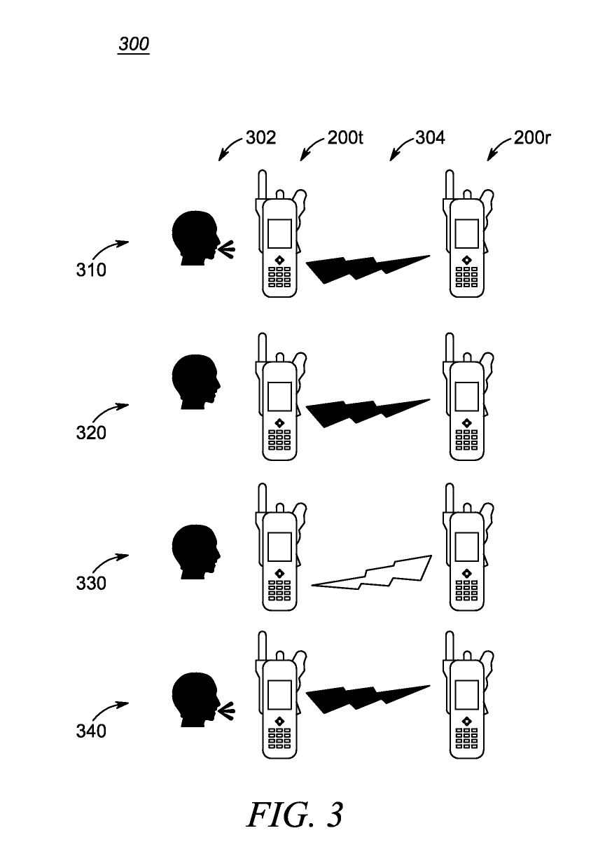

FIG. 3 is a block diagram of an exemplary backchannel operation 300 in a half-duplex communication system in accordance with some embodiments. The backchannel operation 300 includes a transmitting communication device 200t and a receiving communication device 200r. First, the backchannel operation 300 includes a user 302 transmitting via the communication device 200t on a half-duplex communication channel 304 (step 310). For example, the user 302 can be speaking via PTT over the half-duplex communication channel 304. Again, for illustration purposes, the half-duplex communication channel 304 is shown as a wireless channel in a direct connection between the communication devices 200t, 200r. Those of ordinary skill in the art will appreciate other configurations are contemplated.

Next, the communication device 200t detects silence (e.g., an absence of speech) and denotes a VAD flag (step 320). Here, the communication device 200t, such as via its vocoder, detects the absence of speech from the user 302. The communication device 200t can transmit a notification to the communication device 200r, and other devices, that there is a pause in audio and that a back channel is now or will become available on the half-duplex communication channel 304 despite the communication device 200t not relinquishing control of the half-duplex communication channel 304. The notification may specify a number of time slots for the back channel, a starting time slot and an ending time slot, a period of time for the back channel, a starting time and an ending time, or some other combination of parameters to specify the duration and/or location of the back channel. The communication device 200r, upon receipt of notification of the availability of the back channel, can transmit a message or alert via the back channel to the communication device 200t (step 330).

For example, assume the communication devices 200t, 200r are LMR radios. Generally, LMR has a channel data rate of about 9.6 kb/s up to 19.6 kb/s. With about 20 msec to communicate on the back channel, the communication device 200r has a couple bursts of packets that it can send on the back channel to the communication device 200t for specific commands. Again, exemplary specific commands can include alert notifications, commands to terminate transmitting, update notifications, location updates, etc. Finally, once the back channel expires based on, for example, expiration of time slots or a time period allotted to the back channel, the back channel is closed and the communicating device 200t returns to transmitting on the half-duplex communication channel 304 (step 340).

Thus, the method and apparatus described herein operates at both the transmitting communication device 200t, i.e. the device actively transmitting on the half-duplex communication channel 304, and at the receiving communication device 200r, i.e. the device actively receiving on the half-duplex communication channel 304. The transmitting communication device 200t recognizes voice breaks and notifies other devices on the half-duplex communication channel 304 as well as switches from transmitting to receiving for a short period. The receiving communication device 200r receives the notification and switches from receiving to transmitting for the short period if a back channel message needs to be sent. As described herein, this removes the requirement for second network protocols and associated hardware on the communication devices 200t, 200r for back channel communications.

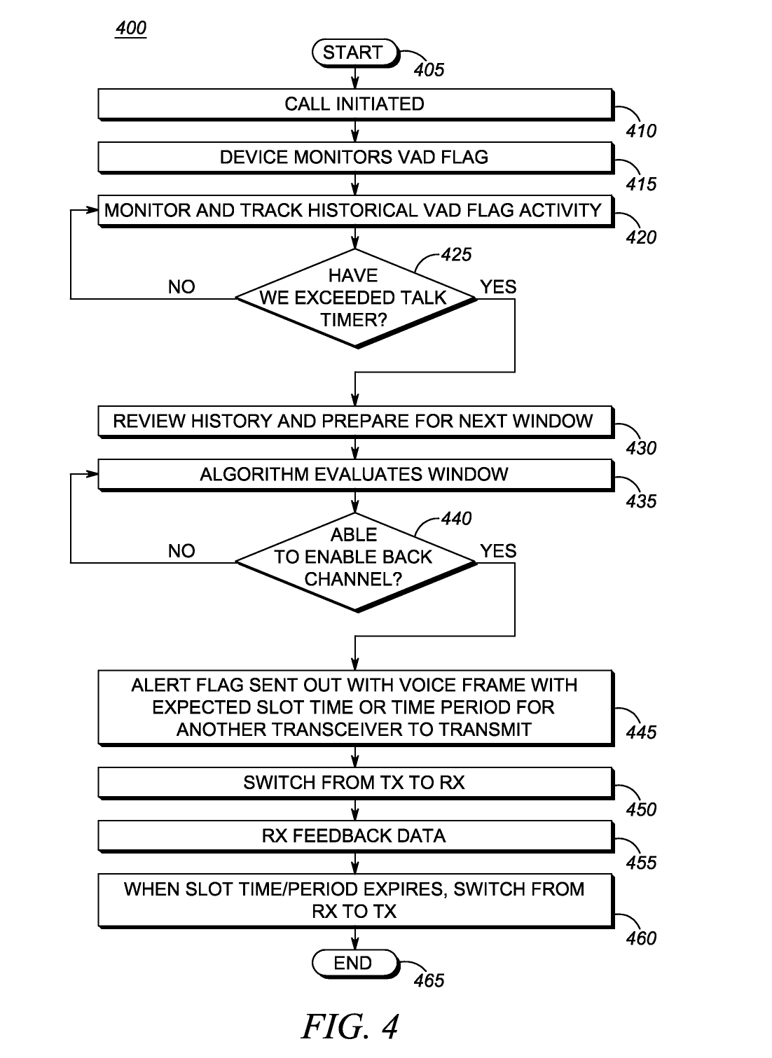

FIG. 4 is a flowchart of a method 400 for a back channel implemented by a transmitting device in a half-duplex communication system in accordance with some embodiments. The method 400 can be implemented by the transmitting communication device 200t as well as other devices. For example, the method 400 can be implemented anytime a communication device is active in transmitting on a half-duplex channel. The method 400 starts (step 405) such as whenever the transmitting device begins transmitting on the half-duplex channel by initiating a call (step 410). Again, the transmitting device can be an LMR radio and the call can be a PTT call. During the call, the transmitting device monitors a VAD flag (step 415). Again, as described herein, the VAD flag indicates silence or a pause in speech where there is an opportunity for the back channel without the transmitting device giving up the half-duplex channel.

The transmitting device can monitor and track historical VAD flag activity (step 420). For example, the transmitting device can monitor recent history to anticipate future speech pauses based on user behavior. The transmitting device can use this process to more accurately anticipate future back channel opportunities based on user behavior. The method 400 checks if the user has exceeded a talk timer (step 425). For example, the method 400 may include the talk timer which is a predefined amount of time before which the method 400 does not explore back channel opportunities. That is, a typical call may be on the order of a couple of seconds, i.e. a short amount of audio, and there may not be a requirement to implement that back channel until after the user has held the half-duplex channel for the talk timer amount of time.

Once the user exceeds the talk timer, the transmitting device can review the history and prepare for a next window for a back channel opportunity (step 430). Here, the method 400 is looking and evaluating a next window for the back channel (step 435). If the transmitting device determines it is able to enable the back channel (step 440), the transmitting device sends an alert flag out with a voice frame with the expected future time slot(s) or time period for another device to transmit (step 445). Here, the method 400 can be a time slot-based system (e.g., time division multiple access (TDMA)), and the transmitting device is alerting other devices of the future time slot (or slots) which can be used as the back channel. That is, the back channel is predefined in terms of future time slots. In other embodiments, the method 400 can be a frequency-based system (e.g., frequency division multiple access (FDMA)), and the transmitting device is alerting other devices of future time period (or periods) which can be used as the back channel. The transmitting device switches from transmitting to receiving (step 450) for the time slot(s) or time period(s) indicated. Here, the transmitting device adjusts the radio accordingly. The transmitting device still maintains control of the half-duplex channel, but momentarily switches to receiving for the back channel. The transmitting device awaits to receive data in the predefined time slot(s) or time period(s) constituting the back channel (step 455). These predefined time slot(s) or time period(s) are expected time slots or expected time period(s) for transmission on the back channel. Note, the transmitting device may or may not receive data on the back channel; this is dependent on whether other devices send messages during the indicated back channel time slot(s) or period(s). When the time slot(s) or time period(s) expire, the transmitting device switches back to transmitting from receiving (step 460). Again, here the transmitting device adjusts the radio accordingly. Finally, the method 400 ends (step 465). If and/or once the transmitting radio has nothing further to transmit, it may relinquish control of the half-duplex channel, and may switch to an idle receive state in which it monitors the half-duplex channel (or some other half-duplex channel) for new calls and/or new call notifications.

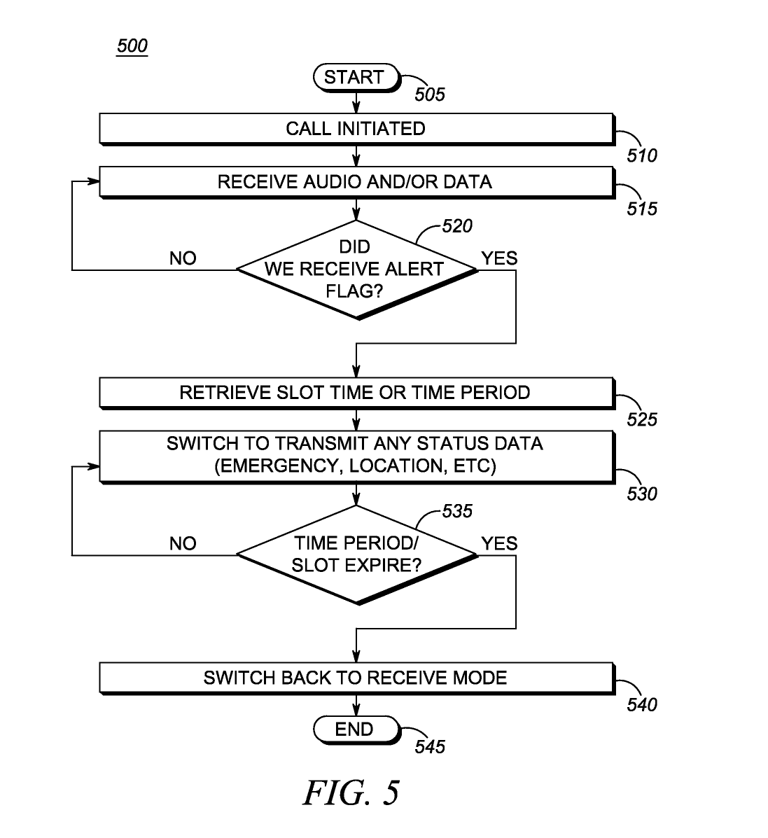

FIG. 5 is a flowchart of a method 500 for a back channel implemented by a receiving device in a half-duplex communication system in accordance with some embodiments. The method 500 can be implemented by the receiving communication device 200r as well as other devices. For example, the method 500 can be implemented anytime a communication device is active in receiving on a half-duplex channel. Also, the methods 400, 500 contemplate concurrent operation in the half-duplex system. The method 500 starts (step 505) with the initiation of a call on the half-duplex channel (step 510). The receiving device receives audio and/or data on the half-duplex channel (step 515) as well as checking whether it receives an alert flag (step 520). The alert flag is sent by the transmitting device to indicate the back channel opportunity as well as associated future time slot(s) or time period(s).

If an alert flag is received at step 520, the receiving device retrieves the slot time(s) or time period(s) for the back channel (step 525) via a received notification from the transmitting device. The receiving device can switch to transmit for providing any information via the back channel, if needed, during the indicated time slot(s) or period(s) (step 530). The receiving device only needs to switch to transmit if there is a message to send on the back channel, such as status data (emergency, location, etc.). If the receiving device has nothing to transmit, it may remain in the receive mode so that it can monitor what other devices may transmit on the back channel, and possibly take action accordingly. The receiving device can queue any information that needs to be sent on a back channel until it receives an alert flag at step 520. Once the time slot(s) or time period(s) are determined to have expired for the back channel (step 535), the receiving device switches back to a receive mode (step 540), so that the receiving device can continue receiving audio and/or data from the transmitting device (if any), and the method 500 ends (step 545).

As described herein, the method and apparatus enable the use of the Voice Activity Detection (VAD) flag to identify if there are small segments of voice gaps that the radio could use as an opportunity to switch from transmitting to receiving to receive status or other alert messaging from the receiver units or alternative transmitting units. This provides ad hoc non-deterministic process to create an opportunistic feedback solution that allows an enhanced communication process compared to a traditional dedicated half-duplex process.

In an exemplary embodiment, the method and apparatus can include FDMA communication devices using PTT. Advantageously, the back channel enables two-way communication on a half-duplex channel without requiring another set of hardware for dual mode operation. In an exemplary application, the back channel can be used to provide alerts, location, etc. For example, the back channel can be used to stop a transmitting device from currently using the half-duplex channel, such as where someone with higher priority needs it or there is an emergency. The transmitting device can be notified via an audio tone and/or display notification. Also, the back channel can be used to turn off the transmitting device's use of the half-duplex channel. Other applications are also considered such as using the back channel to transmit information, e.g. biometrics, location, etc.

Another advantage of the method and apparatus is the use in areas with sporadic network coverage. For example, LMR has longer range often than cellular networks, and this allows even a dual-mode device to receive data while actively transmitting on a half-duplex channel when out of coverage on one network. The method and apparatus can also tie a portable communication device with a user's in-vehicle system (e.g., DVRS). For example, the DVRS can interrupt and provide an alert via the back channel even when the user maintains transmit/control over the half-duplex channel.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for a back channel implemented by a transmitting device in a half-duplex communication system, comprising:
monitoring for voice activity detection, indicative of an absence of human speech, while the transmitting device is transmitting on a half-duplex channel of the half-duplex communication system;
transmitting a notification of a back channel opportunity to other devices on the half-duplex channel responsive to the voice activity detection; and
switching to a receiving mode to receive data on the back channel while still maintaining control of the half-duplex channel.

2. The method of claim 1, further comprising:
transmitting the notification with one of expected time slot(s) and time period(s) for the other devices to transmit on the back channel.

3. The method of claim 2, further comprising:
switching to a transmitting mode subsequent to the switching to receiving step and expiration of the one of the expected time slot(s) and time period(s).

4. The method of claim 1, further comprising:
monitoring and tracking the voice activity detection up to a predetermined time;
determining opportunities for the back channel subsequent to expiration of the predetermined time; and
transmitting the notification based on the determined opportunities.

5. The method of claim 4, wherein the opportunities comprise moments where speech is not detected based on the monitoring and tracking local to the transmitting device.

6. The method of claim 1, further comprising:
receiving the data on the back channel; and
performing an action based on the received data.

7. The method of claim 6, wherein the action comprises interrupting the transmitting device in a push-to-talk application when the received data is indicative of a higher priority user wishing to transmit or an emergency situation.

8. The method of claim 1, wherein the transmitting device utilizes Frequency Division Multiple Access.

9. The method of claim 1, wherein the transmitting device comprises a Land Mobile Radio.

10. A method for a back channel implemented by a receiving device in a half-duplex communication system, comprising:
receiving voice and/or data from a transmitting device on a half-duplex channel of the half-duplex communication system;
detecting a notification of a back channel opportunity from the transmitting device while the transmitting device still maintains control of the half-duplex channel; and
switching to a transmitting mode to transmit a message on the back channel responsive to the notification and a determined need to transmit the message to the transmitting device while the transmitting device still maintains control of the half-duplex channel.

11. The method of claim 10, further comprising:
receiving the notification with one of expected time slot(s) and time period(s) for transmission on the back channel.

12. The method of claim 11, further comprising:
switching to a receiving mode subsequent to the switching to receiving step and expiration of the one of the expected time slot(s) and time period(s).

13. The method of claim 10, further comprising:
detecting a message for transmission to the transmitting device; and
queuing the message until the notification of the back channel opportunity is detected.

14. The method of claim 10, wherein the receiving device utilizes Frequency Division Multiple Access.

15. The method of claim 10, wherein the receiving device comprises a Land Mobile Radio.

16. An apparatus operating a back channel in a half-duplex communication system, comprising:
a network interface configured to communicate on a half-duplex channel in the half-duplex communication system;
a microphone;
a processor communicatively coupled to the network interface and the microphone; and
memory storing instructions that, when executed, cause the processor to:
monitor for voice activity detection, indicative of an absence of human speech, from the microphone while transmitting via the network interface on the half-duplex channel;
transmit a notification of a back channel opportunity to other devices on the half-duplex channel responsive to the voice activity detection; and
switch the network interface to receive data on the back channel while still maintaining control of the half-duplex channel.

17. The apparatus of claim 16, wherein the instructions that, when executed, further cause the processor to:
receive data via the network interface from a transmitting device on a half-duplex channel of the half-duplex communication system;
detect a notification of the back channel from the transmitting device while the transmitting device still maintains control of the half-duplex channel; and
switch the network interface to transmit a message on the back channel responsive to the notification and a need to transmit the message to the transmitting device while the transmitting device still maintains control of the half-duplex channel.

18. The apparatus of claim 16, wherein the network interface utilizes Frequency Division Multiple Access.

19. The apparatus of claim 16, wherein the apparatus comprises a Land Mobile Radio.
